(19) United States
(12) Patent Application Publication
(10) Pub. No.: US 2013/0133697 A1
(43) Pub. Date: May 30, 2013

(54) PREVENTION OF POST-PECVD VACUUM AND ABATEMENT SYSTEM FOULING USING A FLUORINE CONTAINING CLEANING GAS CHAMBER

(71) Applicants: Paul A. STOCKMAN, Hillsborough, NJ (US); Richard HOGLE, Oceanside, CA (US); Hans-Dieter MÄNNLING, Pullach (DE); Ian TRAVIS, Elswick (GB)

(72) Inventors: Paul A. STOCKMAN, Hillsborough, NJ (US); Richard HOGLE, Oceanside, CA (US); Hans-Dieter MÄNNLING, Pullach (DE); Ian TRAVIS, Elswick (GB)

(21) Appl. No.: 13/482,233

(22) Filed: May 29, 2012

Related U.S. Application Data
(60) Provisional application No. 61/502,440, filed on Jun. 29, 2011.
(60) Provisional application No. 61/502,444, filed on Jun. 29, 2011.
(60) Provisional application No. 61/502,449, filed on Jun. 29, 2011.
(60) Provisional application No. 61/502,450, filed on Jun. 29, 2011.
(60) Provisional application No. 61/502,454, filed on Jun. 29, 2011.
(60) Provisional application No. 61/502,458, filed on Jun. 29, 2011.

(51) Int. Cl. B08B 17/02

(52) U.S. Cl. CPC B08B 17/02
USPC 134/22.1

(57) ABSTRACT

Methods and apparatus for reducing post PECVD vacuum and abatement system fouling. Chamber cleaning times are reduced leading to increased efficiency and lower cost fabrication processes by introducing F₂ or a fluorine containing gas into the PECVD system. When using F₂, the cleaning gas may be introduced directly to desired locations of the system where it can interact without activation with unwanted deposits. Alternatively, the cleaning gas may be activated in-situ in the equipment using existing plasma discharge equipment, or the cleaning gas may be activated using an RPS and then introduced to the desired location in its already activated state.

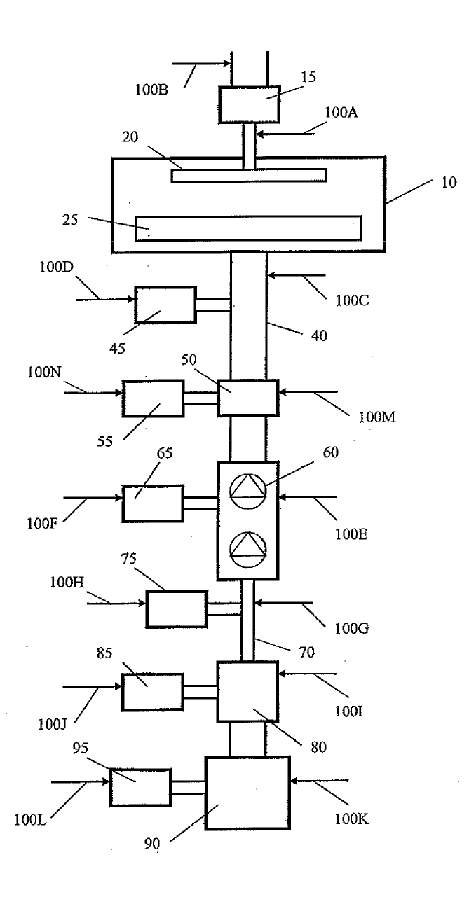

### BACKGROUND OF THE INVENTION

Thin film deposition processes for depositing films of pure and compound materials are known. In recent years, the dominant technique for thin film deposition has been chemical vapor deposition (CVD). A variant of CVD, Plasma Enhanced Chemical Vapor Deposition (PECVD) has been used to manufactured thin-film devices such as integrated circuits, liquid crystal displays and photovoltaic panels. A standard PECVD technique comprising introducing gaseous precursor materials, such as silane and hydrogen, into a vacuum deposition chamber and activating the gases using a plasma discharge device. The energy from the plasma discharge breaks the molecular bonds of the precursor gases resulting in a plasma containing both neutral radical and charged ionic atoms and molecular fragments. Thin films of material, such as silicon, can then be formed on the surface of a substrate, such as a wafer or glass sheet, as the activated plasma reacts with the substrate. Process optimization allows uniform thin films having desired device properties to be quickly formed.

However, the activated plasma species do not only react with the substrate, but rather also deposit on the surfaces of the vacuum chamber, which can lead to contamination of subsequent substrates with undesired chemical reactants or particles that can degrade the function of the device being fabricated. Therefore, these deposits are routinely removed, for example, by introducing fluorine radicals into the chamber between deposition cycles. The fluorine radicals may be produced from a plasma discharge of fluorine containing gas molecules, such as molecular fluorine (F₂), nitrogen trifluoride (NF₃) or sulfur hexafluoride (SF₆). Such plasma activation can be done using the plasma discharge equipment in the chamber, or can be done using an external remote plasma source (RPS). Alternatively, F₂ can be used without activation to react directly with the unwanted deposits. This molecular process can be enhanced by heating the affected surfaces. In either case, the cleaning gas reacts with the unwanted deposits to form gaseous fluorides that are removed from the chamber through the vacuum system and are ultimately abated by burning or aqueous chemical scrubbing. The endpoint for the cleaning cycle, e.g. when the last of the unwanted deposits are converted to gaseous fluorides and pumped out of the chamber, can be detected by pressure change, optical emission change of the plasma, or by chemiluminescence or mass spectrometry of the waste stream.

In addition, to the deposits formed in the chamber, unwanted deposits can also be formed downstream of the chamber, for example, in the vacuum pump or abatement equipment for the system or in conduits connected thereto. The amount of these deposits can vary depending on the chemical nature of the reactants, the size of the chamber and the flow rate of the precursor gases. While these downstream deposits do not pose the same deleterious effects on subsequent substrate processing in the chamber, they can lead to other undesirable effects, generally referred to as fouling. For example, these downstream deposits can restrict the vacuum conductance, abrasive particles may harm the vacuum pump or abatement equipment, and chemical reactions may heat and harm the vacuum pump, abatement equipment or their associated conduits. When forming tandem junction or for micromorph PV processes, where a relatively thick layer (>1 μm) of microcrystalline silicon is deposited, fouling can create a significant risk to manufacturing efficiency because of the amount of reactive material that can accumulate during a single deposition cycle.

While the downstream deposits can also be removed using the cleaning gases noted above, because these areas are downstream of the vacuum chamber, they are cleaned after the chamber cleaning and therefore extend the cleaning cycle resulting in greater down time and lower productivity. In addition, the typical endpoint detection means are not effective in these downstream areas of the system and the inability to monitor the endpoint can result in either incomplete cleaning and deposit accumulation or running the cleaning cycle too long and wasting time and material. Also, because these deposits accumulate unevenly, there is the possibility that enough material will accumulate in a particular area that the cleaning process will result in deleterious localized heating.

Therefore, there remains a need for improvements to the cleaning of deposition chambers and to the prevention of post PECVD vacuum and abatement equipment and conduit fouling.

### SUMMARY OF THE INVENTION

The present invention provides methods and apparatus for reducing post PECVD vacuum and abatement system fouling. By using the present invention, chamber cleaning times can be reduced leading to increased efficiency and lower cost fabrication processes. The advantages of the present invention are accomplished by introducing F₂ or a fluorine containing gas such as F₂, NF₃ or SF₆ into the PECVD system. The cleaning gas may be introduced at different locations of the PECVD system and therefore target specific area and components of the system to avoid fouling. When using F₂ as the cleaning gas, the F₂ may be introduced directly to the targeted area or component where it can interact without activation with any unwanted deposits or materials. Alternatively, the cleaning gas, e.g. F₂, NF₃ or SF₆, may be activated in-situ in areas or components where plasma discharge equipment is already in place or in further alternatives, the cleaning gas e.g. F₂, NF₃ or SF₆, may be activated using an RPS and then introduced to the targeted area or component in its already activated state.

### BRIEF DESCRIPTION OF THE DRAWINGS

The FIGURE is a schematic drawing of an apparatus according to the present invention.

### DETAILED DESCRIPTION OF THE INVENTION

The present invention provides methods and apparatus for reducing post PECVD vacuum and abatement system fouling. Processes for the fabrication of thin films and thin film devices can be improved by utilizing the present invention, wherein chamber and equipment cleaning times can be reduced leading to increased efficiency and lower costs. In general, the present invention provides these advantages by introducing F₂ or a fluorine containing gas into the PECVD system. The cleaning gas can be introduced at a number of different locations throughout the system and in a number of different ways, as will be more fully described below with reference to the drawing FIGURE.

The FIGURE is a schematic drawing of a PECVD system according to the present invention, including a deposition chamber 10 having plasma discharge equipment 20, 25 for activation of the deposition gases. The deposition chamber 10 is fluidly connected with a vacuum pump system 60 through a vacuum pump foreline 40. The vacuum pump system 50 is fluidly connected with abatement equipment 80, 90; for example an abatement burner 80, an aqueous chemical scrubber 90, or both through vacuum pump exhaust line 70. The apparatus of the present invention may also include one or more RPS components, such as RPS 15, RPS 45, RPS 55, RPS 75, RPS 85 or RPS 95. In addition, the apparatus may include a pre-vacuum catch pot 50 used to trap particles of unwanted deposits prior to entering the vacuum pump system 60. The catch pot 50 causes preferential deposition of the unwanted deposits within the catch pot 50 and helps avoid deposition in the vacuum pump system 60 as well as other downstream components.

According to one embodiment of the present invention the cleaning gas 100A may be introduced directly to the deposition chamber 10 where it can interact without activation with the unwanted deposits on the chamber walls. In this embodiment the use of F₂ gas as the cleaning gas is required as it does not require activation to clean the chamber walls.

In another embodiment according to the present invention, the cleaning gas 100A is again introduced directly into the deposition chamber 10, but in this case is activated in situ using the plasma discharge equipment 20, 25, already in place within the deposition chamber 10. In this embodiment, the cleaning gas can be any fluorine containing gas, e.g. F₂, NF₃ or SF₆.

In a further embodiment of the present invention, the cleaning gas 100B is introduced to the deposition chamber 10, through a remote plasma system 15. In this manner, the cleaning gas 100B is activated prior to entering the deposition chamber 10, and can achieve significantly higher activated throughput. Once again, any fluorine containing gas can be used, e.g. F₂, NF₃ or SF₆.

In a further embodiment of the present invention the cleaning gas 100C may be introduced directly to the vacuum pump foreline 40 where it can interact without activation with excess deposition gases or with unwanted deposits on the equipment surfaces. In this embodiment the use of F₂ gas as the cleaning gas is required as F₂ does not require activation to clean the chamber walls. As an alternative, the F₂ is added during the deposition process so that the F₂ can react with the excess precursor materials exiting the deposition chamber 10 and thereby prevent deposition of unwanted material downstream of the deposition chamber 10. In another alternative, the F₂ is added after the deposition process is complete in which case the F₂ reacts with any remaining precursor material exiting the deposition chamber 10 as well as reacting with unwanted deposits that have occurred downstream of the deposition chamber 10. In either alternative, heating of the vacuum pump foreline 40 can enhance the cleaning reaction of the F₂ with the precursor material or unwanted deposits.

In another embodiment according to the present invention, the fluorine containing cleaning gas 100D is introduced to the vacuum pump foreline 40 through a remote plasma system 45. In this manner, the cleaning gas 100D is activated prior to entering the vacuum pump foreline 40. In this embodiment any fluorine containing gas can be used, e.g. F₂, NF₃ or SF₆. In one alternative, the cleaning gas 100D is added during the deposition process so that the cleaning gas can react with the excess precursor materials exiting the deposition chamber 10 and thereby prevent deposition of unwanted material downstream of the deposition chamber 10. In another alternative, the cleaning gas is added after the deposition process is complete in which case the cleaning gas reacts with any remaining precursor material exiting the deposition chamber 10 as well as reacting with unwanted deposits that have occurred downstream of the deposition chamber 10. In either alternative, heating of the vacuum pump foreline 40 can enhance the cleaning reaction of the cleaning gas with the precursor material or unwanted deposits.

The pre-vacuum catch pot 50 may again be included to trap particles of unwanted deposits prior to entering the vacuum pump system 60.

According to the present invention F₂ cleaning gas 100E may be introduced directly to the vacuum pump 60 where it can interact without activation with any unwanted deposits in the vacuum pump 60. The use of F₂ gas is advantageous because F₂ does not require activation to clean the deposits. The F₂ cleaning gas may be added during the deposition process so that the F₂ can react with the excess precursor materials exiting the deposition chamber 10 and thereby prevent deposition of unwanted material in the vacuum pump 60 or downstream of the vacuum pump 60. Alternatively, the F₂ is added after the deposition process is complete in which case the F₂ reacts with any remaining precursor material exiting the deposition chamber 10 as well as reacting with any unwanted deposits that have occurred in the vacuum pump 60 or downstream of the vacuum pump 60. In either alternative, heating of the vacuum pump 60 can enhance the cleaning reaction of the F₂ with the precursor material or unwanted deposits.

In another embodiment according to the present invention, fluorine containing cleaning gas 100F is introduced to the vacuum pump 60 through a remote plasma system 60. In this manner, the cleaning gas 100F is activated prior to entering the vacuum pump 60. In this embodiment any fluorine containing gas can be used, e.g. F₂, NF₃ or SF₆. In one alternative, the cleaning gas 100F is added during the deposition process so that the cleaning gas can react with the excess precursor materials exiting the deposition chamber 10 and thereby prevent deposition of unwanted material in the vacuum pump 60 or downstream of the vacuum pump 60. In another alternative, the cleaning gas is added after the deposition process is complete in which case the cleaning gas reacts with any remaining precursor material exiting the deposition chamber 10 as well as reacting with unwanted deposits that have occurred in the vacuum pump 60 or downstream of the vacuum pump 60. In either alternative, heating of the vacuum pump 60 can enhance the cleaning reaction of the cleaning gas with the precursor material or unwanted deposits.

The pre-vacuum catch pot 50 may be included to trap particles of unwanted deposits prior to entering the vacuum pump 60. The catch pot 50 is used to cause preferential deposition of the unwanted deposits within the catch pot 50 to avoid deposition in the vacuum pump 60 as well as other downstream components.

According to the present invention the cleaning gas 100G may be introduced directly to the vacuum pump exhaust line 70 where it can interact without activation with the unwanted deposits in the exhaust line 70. In this embodiment the use of F₂ gas as the cleaning gas is required as F₂ does not require activation to clean the unwanted deposits. According to one alternative, the F₂ is added during the deposition process so that the F₂ can enhance oxidation and removal of the excess precursor materials exiting the deposition chamber 10 and thereby prevent deposition of unwanted material in the vacuum exhaust line 70 and downstream equipment, such as abatement equipment 80, 90. In another alternative, the F₂ is added after the deposition process is complete in which case the F₂ reacts with any remaining precursor material exiting the deposition chamber 10 as well as reacting with unwanted deposits that have occurred in the vacuum exhaust line 70 and downstream equipment, such as abatement equipment 80, 90. In either alternative, heating of the vacuum pump exhaust line 70 can enhance the cleaning reaction of the F₂ with the precursor material or unwanted deposits.

In another embodiment according to the present invention, the fluorine containing cleaning gas 100H is introduced to the vacuum pump exhaust line 70 through a remote plasma system 75. In this manner, the cleaning gas 100H is activated prior to entering the vacuum pump exhaust line 70. In this embodiment any fluorine containing gas can be used, e.g. F₂, NF₃ or SF₆. In one alternative, the cleaning gas 100H is added during the deposition process so that the cleaning gas can enhance oxidation and removal of the excess precursor materials exiting the deposition chamber 10 that thereby prevent deposition of unwanted material in the vacuum exhaust line 70 and downstream equipment, such as abatement equipment 80, 90. In another alternative, the cleaning gas is added after the deposition process is complete in which case the cleaning gas reacts with any remaining precursor material exiting the deposition chamber 10 as well as reacting with unwanted deposits that have occurred in the vacuum exhaust line 70 and downstream equipment, such as abatement equipment 80, 90. In either alternative, heating of the vacuum pump exhaust line 70 can enhance the cleaning reaction of the cleaning gas with the precursor material or unwanted deposits.

The pre-vacuum catch pot 50 may employed to trap particles of unwanted deposits prior to entering the vacuum pump 60 as the catch pot 50 causes preferential deposition of the unwanted deposits within the catch pot 50 to avoid deposition in the vacuum pump 60 as well as other downstream components.

According to another embodiment of the present invention the cleaning gas 100I may be introduced directly to the abatement burner 80 where it can interact without activation with unwanted deposits in the abatement burner 80. In this embodiment the use of F₂ gas as the cleaning gas is required as F₂ does not require activation to clean the deposits. According to one alternative, the F₂ is added during the deposition process so that the F₂ can enhance oxidation and removal of excess precursor materials entering the abatement burner 80 and thereby prevent deposition of unwanted material in the abatement burner 80. In another alternative, the F₂ is added after the deposition process is complete in which case the F₂ reacts with any remaining precursor material entering the abatement burner 80 as well as cleaning the unwanted deposits that have occurred in the abatement burner 80. In either alternative, heating of the abatement burner 80 can enhance the cleaning reaction of the F₂ with the precursor material or unwanted deposits.

According to another embodiment of the present invention the cleaning gas 100K may be introduced directly to the aqueous chemical scrubber 90 where it can interact without activation with unwanted deposits in the aqueous chemical scrubber 90. As noted above, the use of F₂ gas as the cleaning gas does not require activation to clean the deposits. Again the F₂ may be added during the deposition process to enhance oxidation and removal of the excess precursor materials entering the aqueous chemical scrubber 90 or after the deposition process in complete so that the F₂ reacts with any remaining precursor material entering the aqueous chemical scrubber 90 as well as cleaning unwanted deposits that have occurred in the aqueous chemical scrubber 905. In either alternative, heating of the aqueous chemical scrubber 90 can enhance the cleaning reaction of the F₂ with the precursor material or unwanted deposits.

In a further embodiment of the present invention, F₂ gas is used as the cleaning gas and is introduced to both the abatement burner 80 and the aqueous chemical scrubber 90. This introduction may be done either during the deposition process or after the deposition process is complete and may be enhanced by heating the abatement burner 80 or aqueous chemical scrubber 90 or both.

In another embodiment according to the present invention, the fluorine containing cleaning gas 100J is introduced to the abatement burner 80 through a remote plasma system 85. In this manner, the cleaning gas 100J is activated prior to entering the abatement burner 80. In this embodiment any fluorine containing gas can be used, e.g. F₂, NF₃ or SF₆. In one alternative, the cleaning gas 100J is added during the deposition process so that the cleaning gas can enhance oxidation and removal of the excess precursor materials entering the abatement burner 80 to prevent deposition of unwanted material in the abatement burner 80. In another alternative, the cleaning gas is added after the deposition process is complete in which case the cleaning gas reacts with any remaining precursor material entering the abatement burner 80 as well as cleaning the unwanted deposits that have occurred in the abatement burner 80. In either alternative, heating of the abatement burner 80 can enhance the cleaning reaction of the fluorine containing cleaning gas with the precursor material or unwanted deposits.

According to another embodiment of the present invention the cleaning gas 100L may be introduced to the aqueous chemical scrubber 90 through a remote plasma system 95. In this manner, the cleaning gas 100J is activated prior to entering the aqueous chemical scrubber 90. In this embodiment any fluorine containing gas can be used, e.g. F₂, NF₃ or SF₆. In one alternative, the cleaning gas 100J is added during the deposition process so that the cleaning gas can enhance oxidation and removal of the excess precursor materials entering the aqueous chemical scrubber 90 to prevent deposition of unwanted material in the aqueous chemical scrubber 90. In another alternative, the cleaning gas is added after the deposition process is complete in which case the cleaning gas reacts with any remaining precursor material entering the aqueous chemical scrubber 90 as well as cleaning the unwanted deposits that have occurred in the aqueous chemical scrubber 90. In either alternative, heating of the aqueous chemical scrubber 90 can enhance the cleaning reaction of the fluorine containing cleaning gas with the precursor material or unwanted deposits.

In a further embodiment of the present invention, the cleaning gas e.g. F₂, NF₃ or SF₆ is introduced to both the abatement burner 80 through remote plasma system 85 and the aqueous chemical scrubber 90 through remote plasma system 95. This introduction may be done either during the deposition process or after the deposition process is complete and may be enhanced by heating the abatement burner 80 or aqueous chemical scrubber 90 or both. In another alternative, a single remote plasma system can be used for both the abatement burner 80 and the aqueous chemical scrubber 90.

The pre-vacuum catch pot 50 may employed to trap particles of unwanted deposits prior to entering the vacuum pump 60 as the catch pot 50 causes preferential deposition of the unwanted deposits within the catch pot 50 to avoid deposition in the vacuum pump 60 as well as other downstream components.

The catch pot 50 is installed upstream of the vacuum pump system 60 and serves to trap particles of unwanted particles produced when cleaning the deposition chamber 10 and also to preferentially cause deposition of excess deposition gases into the catch pot 50. In this way, harmful particles and deposits in the vacuum pump system 60 and downstream equipment, such as the abatement equipment 80, 90, can be avoided. In order to clean the catch pot 50, the F₂ cleaning gas 100M may be introduced directly to the catch pot 50 where it can interact without activation with the trapped particles and deposits in the catch pot 50. The use of F₂ gas is advantageous because F₂ does not require activation to clean the deposits. The F₂ cleaning gas may be added during the deposition process to react with the excess precursor materials exiting the deposition chamber 10 and thereby prevent deposition of unwanted material in areas downstream of the catch pot 50, such as the vacuum pump system 60 and abatement equipment 80, 90. Alternatively, the F₂ may be added after the deposition process is complete in which case the F₂ reacts with any remaining precursor material exiting the deposition chamber 10 as well as reacting with the deposits that have preferentially occurred in the catch pot 50. In either alternative, heating of the catch pot 50 can enhance the cleaning reaction of the F₂ with the precursor material or unwanted deposits.

In another embodiment according to the present invention, fluorine containing cleaning gas 100N is introduced to the catch pot 50 through a remote plasma system 55. In this manner, the cleaning gas 100N is activated prior to entering the catch pot. In this embodiment any fluorine containing gas can be used, e.g. F₂, NF₃ or SF₆. Again the cleaning gas 100N may be added during the deposition process or after the deposition process is complete and heating of the catch pot 50 can enhance the cleaning reaction.

The catch pot 50 may be fitted with a gate valve that allows for reaction of the deposits in the catch pot 50 with the fluorine cleaning gas 100M or 100N to be carried out at higher pressure than the pressure maintained throughout the rest of the PECVD system. This provides for a higher degree of cleaning in the catch pot 50 while assuring safety and normal operation in the rest of the PECVD system.

The present invention provides several advantages. In particular, as noted above, the present invention provides methods and apparatus that reduce post PECVD vacuum and abatement system fouling. By following the present invention, chamber cleaning times can be reduced leading to increased efficiency and lower cost fabrication processes. The present invention provides methods and apparatus for preventing or cyclically removing unwanted deposits from areas downstream of the deposition chamber, e.g. in the vacuum system and abatement system and the conduits connected thereto. The present invention can help to reduce or eliminate fouling of the vacuum and abatement equipment and therefore vacuum conductance remains unrestricted, and harm to the vacuum pump or abatement equipment caused by abrasive particles can be avoided. Further, by avoiding the unwanted deposits, problems associated with chemical reactions that may heat and harm the vacuum pump, abatement equipment or their associated conduits is also avoided. The advantages of the present invention include: reduced cleaning time cycles; reduced material consumption; mitigation of chemical reaction, heating and debris damage to the vacuum and abatement equipment and conduits; as well as avoidance of deleterious localized heating from uneven deposit accumulation.

Many modifications and other embodiments of the invention will come to mind to one skilled in the art to which this invention pertains having the benefit of the teachings presented in the foregoing descriptions and the associated drawing. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. A method for reducing post PECVD vacuum and abatement system fouling comprising:
introducing F₂ or a fluorine containing gas into the PECVD system at a predetermined location to interact with unwanted deposits or with waste gas.

2. The method of claim 1 wherein F₂ is introduced without activation.

3. The method of claim 1 further comprising activating the F₂ or fluorine containing gas in-situ.

4. The method of claim 1 further comprising remotely activating the F₂ or fluorine containing gas prior to introduction to the PECVD system.
